(19) United States
(12) Patent Application Publication
(10) Pub. No.: US 2026/0145772 A1
(43) Pub. Date: May 28, 2026

(54) DEVICES AND METHODS FOR CONTROLLED MECHANICAL FAILURE AND SECONDARY IMPACT DAMAGE MITIGATION

(71) Applicant: Textron Innovations Inc., Providence, RI (US)

(72) Inventors: Cheng-Ho Tho, Colleyville, TX (US); Julien Tanguay, Mirabel (CA); Francis Turgeon, Laval (CA); Sebastien Duval, Terrebonne (CA); Anand Kumar Marimuthu, Bangalore (IN)

(73) Assignee: Textron Innovations Inc., Providence, RI (US)

(21) Appl. No.: 18/962,295

(22) Filed: Nov. 27, 2024

(51) Int. Cl. B64C 1/14; B64C 1/06

(52) U.S. Cl. CPC B64C 1/1461; B64C 1/062

(57) ABSTRACT

An aircraft component assembly for controlling mechanical failure due to an object impact and for mitigating a secondary impact against other systems of the aircraft. The aircraft component assembly includes detaching components configured to detach from the assembly in response to an object impact, one or more non-detaching components configured to remain attached during the impact, and a mechanical fuse. The mechanical fuse is configured to focus impact energy from the object impact onto one or more attachment points associated with the detaching components to cause the attachment points to fail and cause controlled detachment of the detaching components while maintaining attachment of the non-detaching components. The detaching components may be configured as frangible components to fragment upon detachment and/or in response to a secondary impact, and/or to be retained by a retainment mechanism to mitigate damage to other aircraft components.

### TECHNICAL FIELD

The present disclosure generally relates to aircraft control systems, and more specifically to devices and methods for controlling the mechanical failure of an aircraft assembly to prevent damage to aircraft components.

### BACKGROUND

Mechanical devices play a crucial role in various industries and applications, enabling us to perform a wide range of tasks and functions. However, these devices often operate in challenging environments that can subject their components to potential damage or failure. In particular, aircraft components face some of the most demanding conditions due to the nature of flight and the harsh environments they encounter. For example, during flight, aircraft components are exposed to significant aerodynamic pressures and stresses. These forces can put considerable strain on different parts and assemblies of the aircraft. As a result, aircraft components are often designed and constructed to withstand these high-pressure environments while maintaining their functionality and structural integrity.

However, beyond the general stresses of flight, aircraft components may also face specific hazards that can pose serious risks to their operation. One particular danger is the potential for object impacts during flight. For example, of the object impacts, bird strikes are perhaps the best known, and most notorious. Bird strikes occur when birds collide with various areas or components of an aircraft. These impacts can cause significant damage to the affected aircraft components, potentially compromising their performance or structural integrity. Of course, other types of object impacts may also pose significant risk of damage to the aircraft.

To address the challenges posed by object impacts, current aircraft systems and components are typically designed to be object-impact resistant. This approach aims to ensure that the aircraft can maintain safe operation even when subjected to impacts from objects up to a certain size. However, achieving this level of impact resistance often requires making vulnerable aircraft components extremely strong and robust.

While strengthening components can effectively mitigate damage from object impacts, this approach introduces its own set of challenges. For example, creating sufficiently strong aircraft components often results in a significant increase in their weight. This additional weight can be problematic due to the strict weight limitations imposed on aircraft design and operation. Excessive weight can negatively impact fuel efficiency, flight range, and overall aircraft performance.

Furthermore, in the event of a severe object impact, there is a risk that a vulnerable aircraft component may become detached from the aircraft. This detachment poses an additional hazard, as the loose component may potentially cause a secondary impact against other systems of the aircraft, which may be critical components such as propeller blades or engines. Such secondary impacts have the potential to inflict even more severe damage to the aircraft, further compromising its safety and operational capabilities, and in some cases may cause catastrophic damage.

### SUMMARY

The present disclosure achieves technical advantages as an aircraft component assembly configured with functionality for controlling mechanical failure due to an object impact and for mitigating a secondary impact against other systems of the aircraft. In particular embodiments, an aircraft component assembly may be configured with functionality to control the manner and location of the mechanical failure, and to mitigate potential secondary impacts. In embodiments, the functionality of the aircraft component assembly of embodiments may include several main functionalities. For example, the aircraft component assembly may be configured to control the mechanical failure of the aircraft component assembly, which may include managing where and how the mechanical failure occurs. This functionality may be achieved through various means, including the use of a mechanical fuse to focus or distribute the impact energy to specific attachment points. This functionality may result in predetermined components of the aircraft component assembly detaching from the aircraft component assembly in a controlled manner. This may operate to enable the aircraft component assembly to control which components of the aircraft component assembly are allowed to detach from the aircraft component assembly in response to an object impact and which components are prevented from detaching from the aircraft component assembly in response to the object impact. Additionally, the aircraft component assembly may be configured to mitigate damage to other systems of the aircraft that may potentially be caused by secondary impacts with the detached components. This secondary impact mitigation may be achieved through various means, such as the use of frangible detaching components configured to break apart or disintegrate upon impact, and/or the implementation of a retainment mechanism configured to prevent the detached components from causing secondary impacts. These functionality of the aircraft component assembly of embodiments may operate to address the challenges of impact resistance, weight limitations, and the potential consequences of component detachment as described above.

For example, in some embodiments, an aircraft component assembly may include one or more detaching components that may be configured to detach from the aircraft component assembly in response to an object impact against the aircraft component assembly and one or more non-detaching components that may be configured to remain attached to the aircraft component assembly during the object impact against the aircraft component assembly. In embodiments, the one or more detaching components may be attached to the aircraft component assembly at one or more attachment points associated with the one or more detaching components, and the one or more non-detaching components may be attached to the aircraft component assembly at one or more attachment points associated with the one or more non-detaching components. A mechanical fuse may be configured to focus an impact energy from the object impact onto the one or more attachment points associated with the one or more detaching components to cause the one or more attachment points associated with the one or more detaching components to fail and to cause a controlled detachment of the one or more non-detaching components from the aircraft component assembly while maintaining attachment of the one or more non-detaching component to the aircraft component assembly. In embodiments, the one or more detaching components may be configured to fragment upon detachment from the aircraft component assembly and/or to be physically retained by a retainment mechanism to mitigate and/or prevent damage to other systems of the aircraft.

The present disclosure provides several technical benefits that are realized by the functionality of the aircraft component assembly of embodiments. For example, the focused and selective detachment functionality may result in an enhanced impact energy dissipation. By allowing specific components to detach in a controlled manner, the aircraft component assembly may absorb and dissipate impact energy more effectively. This may reduce the overall stress on the aircraft structure during an object impact event.

Another benefit that may be realized by the functionality of the aircraft component assembly of embodiments includes improved weight optimization. For example, the ability to use detachable components may allow for lighter materials or designs in certain areas of the aircraft, as these components may not need to withstand the full force of an impact. This may contribute to overall weight reduction and improved fuel efficiency.

Yet another benefit that may be realized by the functionality of the aircraft component assembly of embodiments includes localized damage containment. For example, configuring detachable components as frangible may limit the extent of damage to specific, predetermined areas. This may prevent the propagation of damage to more critical systems or structures within the aircraft. This may also contribute to a reduced risk of cascading failures because by controlling which components detach and how they detach, the aircraft component assembly of embodiments may minimize the risk of one component failure leading to a series of subsequent failures in other aircraft systems.

Still another benefit that may be realized by the functionality of the aircraft component assembly of embodiments includes a simplified post-impact inspection and maintenance. For example, the controlled detachment of specific components may facilitate easier identification of damaged areas and potentially streamline repair or replacement procedures after an impact event.

It is an object of the disclosure to provide an aircraft component assembly configured with functionality for controlling mechanical failure due to an object impact and for mitigating a secondary impact against other systems of the aircraft. It is a further object of the disclosure to provide a method of controlling mechanical failure of an aircraft component assembly. It is a further object of the disclosure to provide an aircraft system. These and other objects are provided by the present disclosure, including at least the following embodiments.

In one embodiment, an aircraft component assembly is provided. The aircraft component assembly includes one or more detaching components configured to detach from the aircraft component assembly in response to an object impact against the aircraft component assembly and one or more non-detaching components configured to remain attached to the aircraft component assembly during the object impact against the aircraft component assembly. In embodiments, the one or more detaching components are attached to the aircraft component assembly at one or more attachment points associated with the one or more detaching components, and the one or more non-detaching components are attached to the aircraft component assembly at one or more attachment points associated with the one or more non-detaching components. The aircraft component assembly may further include a mechanical fuse configured to focus an impact energy from the object impact onto the one or more attachment points associated with the one or more detaching components to cause the one or more attachment points associated with the one or more detaching components to fail and to cause a controlled detachment of the one or more non-detaching components from the aircraft component assembly while maintaining attachment of the one or more non-detaching component to the aircraft component assembly.

In another embodiment, a method of controlling mechanical failure of an aircraft component assembly is provided. The method includes receiving an object impact at the aircraft component assembly, focusing an impact energy from the object impact onto one or more attachment points associated with one or more detaching components of the aircraft component assembly using a mechanical fuse, and detaching the one or more detaching components from the aircraft component assembly in response to the focused impact energy while maintaining attachment of one or more non-detaching components of the aircraft component assembly to one or more attachment points associated with one or more non-detaching components. In embodiments, the one or more detaching components are configured to fragment upon detachment from the aircraft component assembly.

In yet another embodiment, an aircraft system is provided. The aircraft system includes a vent door assembly including a vent door, one or more gooseneck arms, and a strut. The aircraft system also includes a mechanical fuse configured to focus impact energy from an object impact onto one or more attachment points connecting the vent door to the one or more gooseneck arms and the strut, and a retainment mechanism configured to maintain a connection between the vent door and the vent door assembly after detachment of the vent door from the one or more gooseneck arms and the strut in response to the object impact.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims, if any. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 shows an example aircraft system implemented with an aircraft component assembly configured with functionality for controlling a mechanical failure due to an object impact and for mitigating secondary impacts against other systems of the aircraft in accordance with embodiments of the present disclosure.

FIG. 2 shows a diagram of an exemplary aircraft component assembly configured with capabilities and functionality for controlling a mechanical failure due to an object impact and for mitigating secondary impacts against other systems of the aircraft in accordance with embodiments of the present disclosure.

FIG. 3A shows a diagram of a vent door assembly configured with capabilities and functionality for controlling mechanical failure due to an object impact and for mitigating secondary impacts against other systems of an aircraft in which the vent door assembly is installed in accordance with embodiments of the present disclosure.

FIG. 3B shows a diagram of the vent door assembly during operations for controlling the mechanical failure due to an object impact and for mitigating a secondary impact of components of the vent door assembly against other systems of the aircraft in accordance with embodiments of the present disclosure.

FIG. 4 shows a diagram of an exemplary aircraft component assembly configured with capabilities and functionality for controlling a mechanical failure due to an object impact and for preventing secondary impacts against other systems of the aircraft in accordance with embodiments of the present disclosure.

FIG. 5A shows a diagram of a vent door assembly configured with capabilities and functionality for controlling the mechanical failure due to an object impact and for preventing secondary impacts against other systems of an aircraft in which the vent door assembly is installed in accordance with embodiments of the present disclosure.

FIG. 5B shows a diagram of the vent door assembly during operations for controlling the mechanical failure due to an object impact and for preventing a secondary impact of components of the vent door assembly against other systems of the aircraft in accordance with embodiments of the present disclosure.

FIG. 6 is a high-level flow diagram of a method for controlling mechanical failure of an aircraft component assembly and mitigating damage due to potential secondary impacts in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented here-in encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Various embodiments of the present disclosure are directed to techniques for managing the mechanical failure of aircraft component assemblies due to object impacts to mitigate damage to other systems of the aircraft due to secondary impacts. In particular embodiments, an aircraft component assembly may be configured with functionality to control the manner and location of the mechanical failure, and to mitigate potential secondary impacts. In embodiments, the functionality of the aircraft component assembly of embodiments may include two main functionalities. First, the aircraft component assembly may be configured to control the mechanical failure of the aircraft component assembly, which may include managing where and how the mechanical failure occurs. This functionality may be achieved through various means, including the use of a mechanical fuse to focus or distribute the impact energy to specific attachment points. This functionality may result in predetermined components of the aircraft component assembly detaching from the aircraft component assembly in a controlled manner. This may operate to enable the aircraft component assembly to control which components of the aircraft component assembly are allowed to detach from the aircraft component assembly in response to an object impact and which components are prevented from detaching from the aircraft component assembly in response to the object impact. Second, the aircraft component assembly may be configured to mitigate damage to other systems of the aircraft that may potentially be caused by secondary impacts with the detached components. This secondary impact mitigation may be achieved through various means, such as the use of frangible detaching components configured to break apart or disintegrate upon impact, and/or the implementation of a retainment mechanism configured to prevent the detached components from causing secondary impacts. These functionality of the aircraft component assembly of embodiments may operate to address the challenges of impact resistance, weight limitations, and the potential consequences of component detachment as described above.

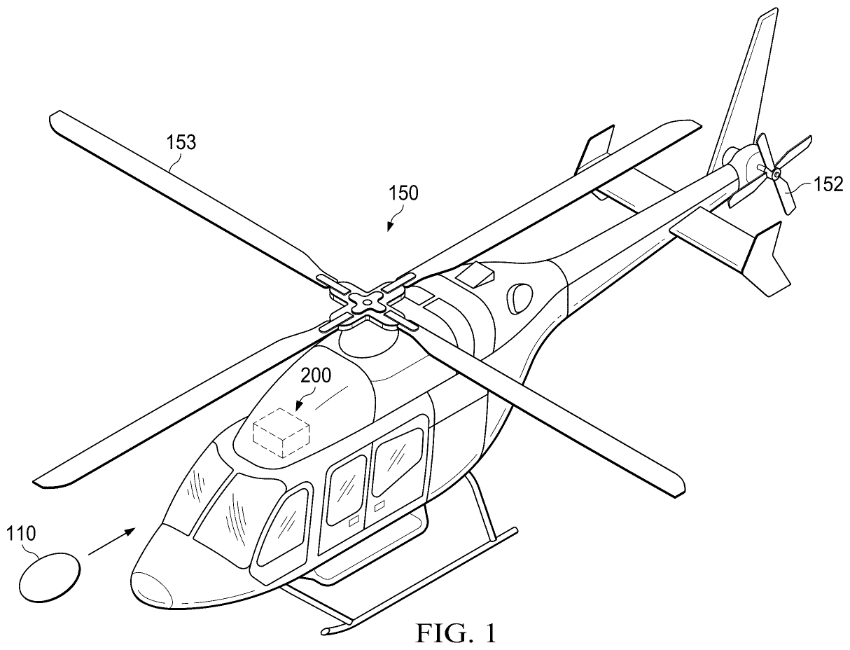

FIG. 1 shows an example aircraft system 150 implemented with an aircraft component assembly 200 configured with functionality for controlling a mechanical failure due to an object impact and for mitigating secondary impacts against other systems of the aircraft in accordance with embodiments of the present disclosure. As shown in FIG. 1, the aircraft system 150 may be a helicopter implemented with the aircraft component assembly 200. It is noted that, in some embodiments, the techniques and devices described herein may be used in aircraft systems of a type other than a helicopter system, such as fixed-wing aircraft, vertical takeoff and landing (VTOL) aircraft, etc.

In this example, the aircraft system 150 includes a rotor blade 152, which may be a tail rotor blade, a main rotor blade 152, and the aircraft component assembly 200. In this example, the main rotor blade 153 may be disposed at the top of the aircraft system 150, extending outward from the main body, and the tail rotor blade 152 may be disposed at the tail end of the aircraft system 150, extending vertically outward. The aircraft component assembly 200 may be disposed on the forward portion of the aircraft system 150. It is noted that, due to the particular layout and configuration of the aircraft system 150, if a part or component of the aircraft component assembly 200 were to become detached, such as due to an object impact, the detached component may have a high probability of striking the tail rotor blade 152 and/or the main rotor blade 153. This spatial relationship between the aircraft component assembly 200 and the aircraft system's rotor blades (e.g., the tail rotor blade 152 and/or the main rotor blade 153) highlights the significance and advantage of the functionality of the aircraft component assembly 200 for controlling mechanical failure and mitigating secondary impacts as disclosed in embodiments of the present disclosure.

In embodiments, the aircraft component assembly 200 may be exposed or vulnerable to an object impact. For example, an object 110, which may be any kind of foreign object (e.g., a bird, etc.) is shown as approaching the aircraft system 150. The object 110 is shown with a trajectory towards the aircraft component assembly 200, indicating a potential for impact with the aircraft component assembly 200. In embodiments, the aircraft component assembly 200 may include functionality according to the present disclosure for controlling a mechanical failure due to an impact with the object 110, as described herein, and for mitigating potential secondary impacts due to the controlled mechanical failure.

For example, in embodiments, the aircraft component assembly 200 may include one or more detaching components configured to detach in a controlled manner upon impact with an object, such as object 110. This controlled detachment may operate to mitigate the potential for secondary impacts with other systems of the aircraft system 150. For example, in embodiments, the detached components may be configured as frangible components configured to break apart or disintegrate upon impact, which may reduce the potential for damage to other systems, such as tail rotor blade 152 and/or main rotor blade 153. Alternatively, or additionally, a retainment mechanism may be used to keep the detached components tethered to the aircraft component assembly 200, which may prevent the detached components causing secondary impacts.

In some embodiments, the controlled detachment functionality of the aircraft component assembly 200 may include configuration to absorb the energy of the object impact and focus the energy to a specific area or point of the aircraft component assembly 200 that is configured to fail in a controlled manner. In embodiments, the specific area or point of the aircraft component assembly 200 against which the impact energy is focused may include the attachment points to which the one or more detaching components are attached. This configuration may allow for the controlled detachment of the one or more detaching components while maintaining the integrity of other non-detaching components.

In some embodiments, the aircraft component assembly 200 may include any component of the aircraft system 150 that may be exposed or vulnerable to an object impact. For example, the aircraft component assembly 200 may include a vent door assembly, an intake assembly, and/or any other component that may be subject to object impacts during flight. The specific configuration and design of the aircraft component assembly 200 may vary depending on the specific requirements and constraints of the aircraft system 150.

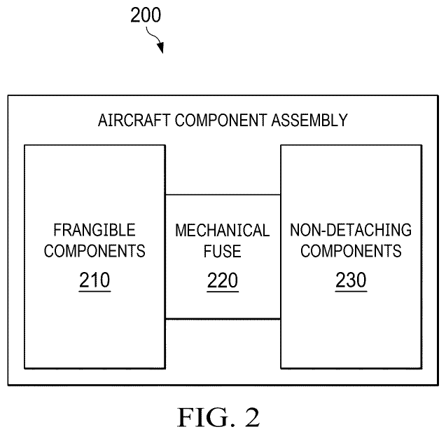

FIG. 2 shows a diagram of an exemplary aircraft component assembly 200 configured with capabilities and functionality for controlling a mechanical failure due to an object impact and for mitigating secondary impacts against other systems of the aircraft in accordance with embodiments of the present disclosure. In embodiments, the aircraft component assembly 200 may be implemented in an aircraft such as aircraft system 150 shown in FIG. 1. As shown in FIG. 2, aircraft component assembly 200 may include one or more frangible components 210, one or more detaching components 230, and a mechanical fuse 220.

In embodiments, the aircraft component assembly 200 may be configured to control the mechanical failure of the aircraft component assembly 200 due to an object impact and to mitigate damage to other systems of the aircraft due to secondary impacts with detached components.

In embodiments, the functionality of the aircraft component assembly 200 to control the mechanical failure of the aircraft component assembly 200 due to an object impact may include functionality to manage where and how the mechanical failure occurs. For example, in embodiments, the aircraft component assembly 200 may be configured to absorb the energy of the object impact against the aircraft component assembly 200 and to focus the impact energy on a specific area or point of the aircraft component assembly 200 that is configured to fail in a controlled manner. In this manner, the mechanical failure of the aircraft component assembly 200 may be configured to occur at a predetermined point of the aircraft component assembly 200. This configuration may allow the control of how and where the mechanical failure due to the object impact occurs.

In embodiments, the configuration to control the mechanical failure may include configuring the one or more frangible components 210 as detaching components configured to separate or detach from the aircraft component assembly 200 in response to the object impact, while configuring the one or more non-detaching components 230 to remain attached to the aircraft component assembly 200 even after the object impact. In embodiments, as the aircraft component assembly 200 includes functionality to focus the impact energy on a specific point to control where and how the mechanical failure due to the object impact occurs, the aircraft component assembly 200 is able to configure the mechanical failure such that the mechanical failure results in the one or more frangible components 210 becoming detached while the one or more non-detaching components 230 remain attached to the aircraft component assembly 200.

In embodiments, the functionality of the aircraft component assembly 200 to focus or distribute the impact energy from an object impact onto a specific area or point of the aircraft component assembly 200 to control where and how the mechanical failure due to the object impact occurs may include functionality to focus the impact energy onto one or more attachment points associated with the one or more frangible components 210. In embodiments, these attachment points may include the one or more points at which the one or more frangible components 210 may be attached to the aircraft component assembly 200 and/or to the non-detaching components 230 of the aircraft component assembly 200.

In embodiments, the configuration of the aircraft component assembly 200 to control the mechanical failure due to an object impact may include configuring the mechanical fuse 220 such that, upon the object impact, the impact energy may be focused on the one or more attachment points associated with the one or more frangible components 210. This focused impact energy may cause the one or more attachment points associated with the one or more frangible components 210 to fail and may result in the one or more frangible components 210 detaching from attachment points, which may be attached to the aircraft component assembly 200 directly and/or the non-detaching components 230, while the one or more non-detaching components 230 remain securely attached to the aircraft component assembly 200. In this manner, the impact energy of the object impact may be absorbed by the mechanical fuse at the one or more attachment points associated with the one or more frangible components 210 and used to break the attachment points associated with the one or more frangible components 210 while maintaining the integrity of the attachment points associated with the one or more non-detaching components 230.

In embodiments, the energy threshold for causing failure at the attachment points associated with the one or more frangible components 210 may be dependent on the specific configuration of the mechanical fuse 220. For example, the mechanical fuse 220 may be configured to include a failure energy value for each of the attachment points associated with the one or more frangible components 210. This failure energy value may define the energy level at which each attachment point may experience mechanical failure.

For example, a first frangible component from the one or more frangible components 210 may be secured to the aircraft component assembly 200 via one or more attachment points that are part of the mechanical fuse 220. These attachment points may connect the first frangible component directly to a plenum of the aircraft component assembly 200, or may link the first frangible component to one or more of the non-detaching components. In either case, each attachment point within the mechanical fuse 220 may be characterized by a respective failure energy value. In embodiments, the failure energy value associated with an attachment point may represent the energy threshold at which the attachment point may experience mechanical failure if subjected to or exposed to that level of energy. When an attachment point associated with the first frangible component fails mechanically, it may result in the first frangible component no longer being secured to the aircraft component assembly 200 at that particular failed attachment point.

In embodiments, the failure energy values of the one or more attachment points of the mechanical fuse 220 may be the same across all of the one or more attachment points. In this manner, an object impact of a sufficient magnitude may cause all of the one or more attachment points to fail detaching the one or more frangible components 210.

In some embodiments, the mechanical fuse 220 may be configured with varying failure energy values across different attachment points. This configuration may allow for a more controlled response to impact events. For example, the failure energy values may be configured to create a detachment hierarchy, where some frangible components of the one or more frangible components 210 may be configured to separate before other frangible components under specific impact conditions.

In embodiments, the relationship between failure energy values of different attachment points may be configured to achieve predetermined and/or desired outcomes. In some embodiments, the failure energy value of an attachment point connecting a frangible component to a non-detaching component may be set as a fraction of the failure energy value of an attachment point securing the non-detaching component to the main aircraft component assembly 200, and/or a fraction of the failure energy value of an attachment point securing the non-detaching component to another non-detaching component. This differential in failure energy values may be leveraged to control the mechanical failure to allow the frangible component to detach from the aircraft component assembly 200 while the non-detaching component is maintained attached during an impact event. In one particular non-limiting example, the failure energy value of an attachment point connecting a frangible component to a non-detaching component may be set as a value between 0.05 and 0.3 of the failure energy value of an attachment point securing the non-detaching component to the main aircraft component assembly 200 (e.g., directly or through a support structure), and/or a value between 0.05 and 0.3 of the failure energy value of an attachment point securing the non-detaching component to another non-detaching component.

For example, an object may impact the aircraft component assembly 200 with an energy level that exceeds the failure energy value of the attachment point between a frangible component and a non-detaching component, but is below the failure energy value of the attachment point between the non-detaching component and the aircraft component assembly 200. In this example, the object impact may result in the detachment of the frangible component from the non-detaching component while the non-detaching component remains securely fastened to the aircraft component assembly 200. This selective detachment behavior provided by the mechanical fuse may enable the functionality of the aircraft component assembly 200 for controlled mechanical failure and mitigation of secondary impacts. For example, the selective detachment functionality may allow for the controlled detachment of the one or more frangible components 210, which may be configured to break away or disintegrate upon impact, potentially reducing the risk of the one or more frangible components 210 causing secondary damage to other systems of the aircraft. At the same time, this selective detachment functionality may ensure that the one or more non-detaching components 230, which may be reinforced to maintain the structural integrity of the aircraft component assembly 200, remain securely attached even under significant impact forces, preventing the risk that the one or more non-detaching components 210 may cause damage to other systems of the aircraft.

In some embodiments, the distribution of failure energy values across different attachment points may be configured to define a sequence and manner in which the one or more frangible components 210 detach from the aircraft component assembly 200 during an impact event. This may allow for precise control over the detachment process, which may minimize the risk of secondary impacts and may optimize the overall safety performance of the aircraft component assembly 200. In some embodiments, minimizing the risk of secondary impacts may include minimizing the risk that a secondary impact may occur and/or minimizing the energy of the objects that become detach and potentially cause the secondary impacts. For example, a smaller frangible component detaching from the aircraft component assembly 200 may have a smaller probably of impacting another component of the aircraft component assembly 200 than a larger frangible component, and/or may carry less kinetic energy (e.g., may cause less damage) than the larger frangible component.

In some embodiments, the configuration of the mechanical fuse 220 to focus the impact energy of an object impact onto the one or more attachment points may include configuration to include regions of weakened materials at the one or more attachment points. These regions of weakened materials may be configured to have a predetermined failure energy value, allowing for controlled failure when subjected to object impact forces. The configuration of these weakened regions may be calibrated to ensure sufficient strength for normal aircraft operations while still facilitating the mechanical failure response during object impact events.

In embodiments, the weakened material regions may be created through various techniques. For example, in some embodiments, the thickness of the material at attachment points may be reduced in certain areas, creating zones that may be more susceptible to deformation or failure under specific load conditions. Alternatively, the material composition at these attachment points might be altered to include elements or structures that yield at predetermined stress levels. In some embodiments, the configuration of the weakened regions may be configured to affect the direction and manner of component detachment. For example, the orientation and shape of the weakened regions may be configured to promote separation of the one or more frangible components 210 in a specific direction, which may operate to guide the detached one or more frangible components 210 away from other systems of the aircraft.

In embodiments, the mechanical fuse 220 may include fasteners configured to attach the one or more frangible components 210 to the one or more attachment points (e.g., to the non-detaching components 230 and/or to a plenum or other structural component of the aircraft component assembly 200 directly). In embodiments, the fasteners may be configured to fail at a predetermined energy level when subjected to the impact force of an object impact. The failure characteristics of these fasteners may enable the controlled detachment process of the one or more frangible components 210.

In embodiments, the failure point of the fasteners, which may be defined by the failure energy level of the attachment point, can be configured by the selection of the material composition of the fasteners. For example, different materials may exhibit varying mechanical properties, which may allow precise control over the failure point at which the fasteners yield under stress. This material selection process may enable fine-tuning of the failure energy threshold to match specific design requirements and impact scenarios. For example, in one embodiment, aluminum may be used as a fastener material due to its unique properties. When an object impact occurs, the force exerted on the one or more frangible components 210 may cause them to pull away from the non-detaching components 230. In response to this force, the aluminum fasteners may undergo elongation before ultimately failing. This elongation process may absorb some of the impact energy, potentially reducing the severity of the impact on other aircraft systems. Once the fasteners elongate beyond their yield point, they may no longer be able to retain the one or more frangible components 210, allowing for controlled detachment of the one or more frangible components 210.

In embodiments, the fasteners of the mechanical fuse 220 may be configured with specific geometric configurations to further control the failure point of the fasteners and the detachment of the one or more frangible components 210. For example, countersink fasteners with a conical shape may be used, as these countersink fasteners may exhibit a lower pull-through resistance due to the inherent weakening of the face material caused by the conical geometry. This configuration may allow for a more predictable and controlled failure under impact conditions.

In some embodiments, the fasteners may be configured with weak points that may be placed and/or configured to facilitate controlled breakage of the fasteners. In embodiments, these weak points may be created through various methods, such as localized thinning of the fastener material or the introduction of stress concentration features. In embodiments, the weak points may be configured to allow the fasteners to maintain sufficient strength to withstand normal operational loads while still allowing for controlled failure when subjected to impact forces exceeding typical operational parameters.

In some embodiments, the fasteners may include adhesive elements configured to maintain a strong bond sufficient to hold the one or more frangible components 210 under normal operating conditions but to allow for separation of the one or more frangible components 210 from the attachment points when exposed to forces beyond a predetermined threshold.

In some embodiments, the failure characteristics of the fasteners may be controlled by removing material. For example, perforations or other forms of selective material reduction may be introduced at specific locations along the fastener. These features may operate as predetermined breaking points, allowing the fastener to fail when the fastener is subjected to impact forces and to allow the one or more frangible components 210 to detach.

In embodiments, the configuration of the fasteners of the mechanical fuse 220 may be configured to ensure that the fastener can withstand the range of forces encountered during normal aircraft operation without failing, including aerodynamic pressures and vibrations. However, when subjected to impact forces that exceed these normal operational parameters, the fasteners may be configured to fail in a controlled manner, facilitating the one or more frangible components 210 while minimizing the risk of uncontrolled separation or secondary impacts.

In embodiments, the one or more non-detaching components 230 may be configured to withstand the impact forces of energies from an object impact without detaching from the aircraft component assembly 200 or experiencing structural failure. For example, in embodiments, the one or more non-detaching components 230 may be made of high-strength, impact-resistant materials. These materials may possess high mechanical properties, such as high tensile strength, fracture toughness, enhanced impact resistance, etc. For example, composite materials, high-strength alloys, and/or specially engineered polymers may be used to reinforce the one or more non-detaching components 230.

In embodiments, the materials used for the one or more non-detaching components 230 may affect the failure energy coefficient of the one or more non-detaching components 230. In embodiments, the failure energy coefficient of a component (e.g., of a detaching component of the one or more non-detaching components 230 and/or of a frangible component of the one or more frangible components 210) may represent the amount of energy the component can absorb before experiencing mechanical failure. Materials with higher failure energy coefficients may be capable of withstanding more severe impact events without breaking, shattering, or fragmenting than materials with a lower failure energy coefficient.

In some embodiments, the failure energy coefficient of the one or more non-detaching components 230 may be configured to be substantially higher than the failure energy coefficient of the one or more frangible components 210, which may operate to ensure that the one or more non-detaching components 230 remain undamaged even when the one or more frangible components 210 detach as intended.

In embodiments, the one or more non-detaching components 230 may include features configured to enhance the resistance of the one or more non-detaching components 230 to impact forces. For example, the one or more non-detaching components 230 may include reinforced geometries, placement of support structures, the inclusion of energy-absorbing elements, etc., which many operate to distribute impact forces more effectively throughout the one or more non-detaching components 230 and may reduce the likelihood of mechanical failure of the one or more non-detaching components 230.

In some embodiments, reinforcing the one or more non-detaching components 230 may include reinforcing the attachment points associated with the one or more non-detaching components 230 (e.g., the point or points at which the one or more non-detaching components 230 attach to the plenum of the aircraft component assembly). In embodiments, reinforcing the attachment points associated with the one or more non-detaching components 230 may include the use of high-strength fasteners, bonding techniques, interlocking designs that resist separation under high-stress conditions, etc. The reinforced attachment points may be configured to ensure that the one or more non-detaching components 230 remain securely attached to the aircraft component assembly 200, even when subjected to forces that would cause the one or more frangible components 210 to detach.

In embodiments, the functionality of the aircraft component assembly 200 to mitigate damage to other systems of the aircraft due to secondary impacts may be implemented as configuration of the one or more frangible components 210 to mitigate damage to other systems of the aircraft due to secondary impacts.

In embodiments, the one or more frangible components 210 may be configured with structural characteristics to mitigate potential damage to other aircraft systems in the event of detachment. For example, in embodiments, the one or more frangible components 210 components may be configured to undergo controlled fragmentation upon impact, resulting in the creation of smaller, less harmful pieces. The fragmentation of the one or more frangible components 210 may include various mechanisms. For example, in some embodiments, the one or more frangible components 210 may be configured to fragment into small pieces of a size that is no likely to cause significant damage to other systems of the aircraft. In some embodiments, the one or more frangible components 210 may be configured to shred into thin, ribbon-like strips that lack the mass or rigidity to cause significant damage to other systems of the aircraft. Alternatively, the components may be configured to disintegrate into a fine powder or small granules upon impact, effectively dispersing the energy and reducing the risk of concentrated force on other systems of the aircraft.

In some embodiments, the one or more frangible components 210 may be configured to break or fragment along predetermined stress lines or weak points. This controlled fragmentation may result in fragments of specific sizes and shapes that are less likely to cause damage to critical aircraft systems such as propeller blades, engines, sensitive electronic equipment, flight control surfaces, etc. The size and shape of these fragments may be configured to ensure they do not possess sufficient mass or aerodynamic properties to inflict damage even if they come into contact with other parts of the aircraft.

The material composition of the one or more frangible components 210 may determine the fragmentation behavior of the one or more frangible components 210. For example, in some embodiments, the one or more frangible components 210 may be constructed from materials that exhibit brittle fracture characteristics under high-stress conditions. Such materials may shatter into small pieces upon impact, rather than breaking into larger, potentially more harmful fragments. Additionally, composite materials with specifically designed failure modes may be utilized to achieve the desired fragmentation behavior.

In some embodiments, the one or more frangible components 210 may include energy-absorbing structures or materials, which may be configured to facilitate the dissipation of the impact energy through deformation or crushing, which may further reduce the potential for the one or more frangible components 210 to cause damage to other aircraft systems after detachment. The energy absorption may also contribute to the fragmentation process, ensuring that the resulting pieces have lower kinetic energy.

In embodiments, the one or more frangible components 210 may be configured to fragment at different stages of the impact event. In some embodiments, the one or more frangible components 210 may be configured to fragment during the initial object impact, dispersing the impact energy and reducing the risk of damage to the aircraft structure due to secondary impacts. Alternatively, or additionally, the one or more frangible components 210 may be configured to separate or detach from the assembly in a whole or substantially whole form during the initial object impact but may be configured to fragment upon a secondary impact with another system of the aircraft. For example, if a detached frangible component were to come into contact with a critical system such as a propeller or engine, the frangible component may be configured to break apart into smaller, less harmful pieces upon this secondary impact, without causing significant damage to the system. This fragmentation during the secondary impact may help dissipate the secondary impact energy and may reduce the potential for significant damage to the other aircraft system. The specific fragmentation behavior may be configured to the particular requirements and potential impact scenarios of the aircraft configuration.

In embodiments, the configuration of the one or more frangible components 210 and the one or more non-detaching components 230 may include a disparity between the failure energy coefficients of the one or more non-detaching components 230 and the one or more frangible components 210. In embodiments, the failure energy coefficient disparity may be intentional and configured to ensure that the one or more non-detaching components 230 remain intact and attached to the aircraft component assembly 200 during impact events that may cause the one or more frangible components 210 to detach or break apart from the aircraft component assembly.

For example, in embodiments, the failure energy coefficient of the one or more non-detaching components 230 may be configured to be substantially higher than the failure energy coefficient of the one or more frangible components 210. This difference in failure energy coefficients may be configured to implement the controlled failure mechanism of the aircraft component assembly 200. In some specific embodiments, the failure energy coefficient of the one or more frangible components 210 may be set to a fraction of failure energy coefficient of the one or more non-detaching components 230. For example, in a specific example, the failure energy coefficient of the one or more frangible components 210 may range from 5% to 30% of the failure energy coefficient of the one or more non-detaching components 230.

It should be noted that the specific ratios between the failure energy coefficients of the one or more frangible components 210 and the one or more non-detaching components 230 discussed herein are provided by way of illustration and are not intended to be limiting in any way. Indeed, the specific ratios between the failure energy coefficients of the one or more frangible components 210 and the one or more non-detaching components 230 may vary depending on the particular application, configuration, and/or component parts involved. The exact percentages may be configured to meet the requirements of different aircraft systems, taking into account factors such as the expected impact forces, the critical nature of the components, the overall safety objectives of the aircraft design, etc.

In some embodiments, the ratio between the failure energy coefficients of the one or more frangible components 210 and the one or more non-detaching components 230 may be adjusted based on the specific location and function of the components within the aircraft. For example, components in areas more prone to impact may have different failure energy coefficient ratios compared to those in more protected areas. The process of determining the appropriate ratio between the failure energy coefficients of the one or more frangible components 210 and the one or more non-detaching components 230 may include testing and analysis. Operators may utilize computer simulations, physical prototypes, real-world testing, etc. to fine-tune the ratios, ensuring that the ratios provide a balance between controlled detachment of frangible components and the structural integrity of non-detaching components under various impact scenarios.

In embodiments, the one or more frangible components 210 may be configured as non-damaging components. In these embodiments, the one or more frangible components 210 may be configured to minimize or prevent the damage caused to other systems of the aircraft during a secondary impact. For example, in embodiments, the one or more frangible components 210 may be constructed from materials selected for their non-damaging properties. These materials may be configured to maintain structural integrity during normal operation while exhibiting benign characteristics upon secondary impact after detachment. For example, the one or more frangible components 210 may be constructed from advanced composites or polymers that may have sufficient structural strength for normal operation but deform or yield in a manner that minimizes potential harm to other aircraft systems in the event of a secondary impact.

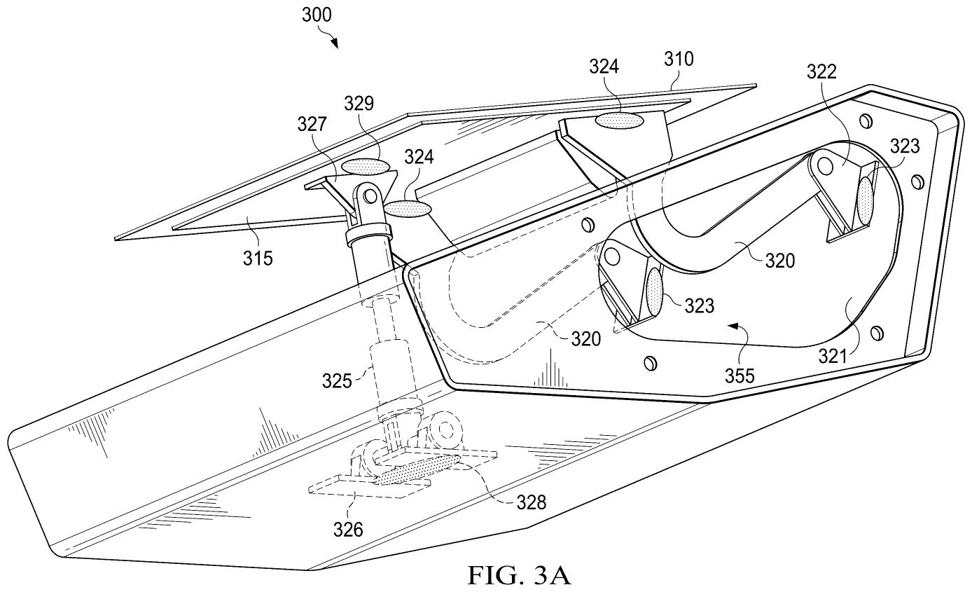

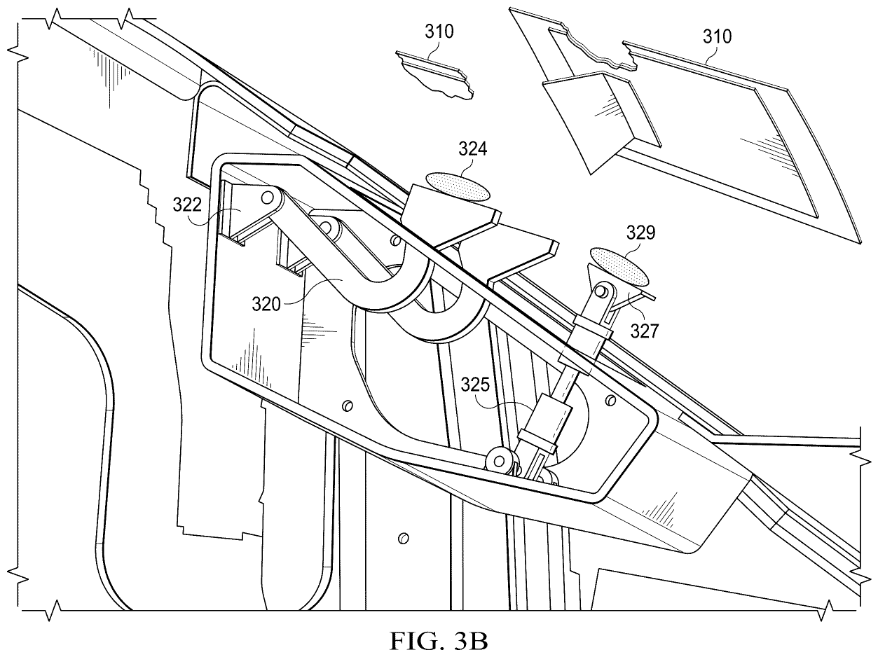

FIG. 3A shows a diagram of a vent door assembly 300 configured with capabilities and functionality for controlling mechanical failure due to an object impact and for mitigating secondary impacts against other systems of an aircraft in which the vent door assembly 300 is installed in accordance with embodiments of the present disclosure. Vent door assembly 300 may represent a particular implementation of the aircraft component assembly 200 described with reference to FIG. 2 and may include the functionalities described with respect to aircraft component assembly 200.

In embodiments, the vent door assembly 300 may be configured to regulate the flow of ram air into an aircraft cabin. The vent door assembly 300 may be positioned in various locations on the aircraft to optimize air intake efficiency. For example, the vent door assembly 300 may be installed near the front of the aircraft, where it can take advantage of the high-pressure airflow generated during flight. In some embodiments, the assembly may be placed into the aircraft's at various locations such as the nose area, the windshield surrounding structure, the sides of the cabin, the roof of the aircraft, etc. The specific placement of the vent door assembly 300 may be determined based on factors such as aircraft type, intended flight profiles, cabin pressurization requirements, etc.

In embodiments, the vent door assembly 300 may include a mechanism that allows for adjustable positioning between open and closed states. When in the open position, the vent door assembly 300 may allow a substantial amount of ram air to flow into the aircraft. Conversely, when closed, the assembly may effectively seal off the air intake, which may be desirable during certain flight phases or environmental conditions. The transition between the open and closed states may be facilitated by the strut 325.

In embodiments, the vent door assembly 300 may include several components that cooperatively operate to provide controlled airflow and structural integrity. For example, the vent door assembly 300 may include a vent door 310, that may be supported and articulated by one or more gooseneck arms 320, which may provide the necessary range of motion for opening and closing operations. A strut 325 may be included to offer additional support and stability to the structure.

In embodiments, the vent door 310 may be attached to the one or more gooseneck arms 320 at one or more attachment points 324 and may be attached to the strut 325 at attachment point 329. A plenum 321 may operate as the main body or structure for the vent door assembly 300. In this example, the one or more gooseneck arms 320 may be attached to the plenum 321 at attachment points 323, and the strut 325 may be attached to the plenum 321 at attachment point 326. In this example, the one or more gooseneck arms 320 and the strut 325, and their associated support structures, may be disposed within enclosure 355, while the vent door 310 may be configured to abut an opening into the enclosure 355 while in the closed position.

In embodiments, the configuration of the vent door assembly 300 for controlling mechanical failure due to an object impact and for mitigating secondary impacts against other systems of the aircraft may include implementing a combination of detaching and non-detaching components. For example, in the configuration illustrated in FIG. 3A, the vent door 310 may be configured as a detaching component, and may be configured to separate or detach from the vent door assembly 300 in a controlled manner during an impact event. In contrast, the one or more gooseneck arms 320 and the strut 325, as well as their associated support structures (e.g., support structures 322, 326, and/or 327) may be configured as non-detaching components, and may be configured to remain securely attached to the vent door assembly 300 even during the impact event.

In embodiments, configuring the non-detaching components of the vent door assembly 300 (e.g., the one or more gooseneck arms 320 and the strut 325, and their associated support structures) may include reinforcing the attachment points of these components and/or their associated support structures. For example, the attachment between the one or more gooseneck arms 320 and the plenum 321 may be strengthened through various means. One or more support assemblies 322 may be used as intermediaries between the one or more gooseneck arms 320 and the plenum 321, and may be configured to attach the one or more gooseneck arms 320 to the plenum 321 at the one or more attachment points 323. In embodiments, the one or more support assemblies 322 may be reinforced, such as by constructing the one or more support assemblies 322 from reinforced materials in accordance with embodiments of the present disclosure described herein. In some embodiments, fasteners may be used to secure the one or more support assemblies 322 to the plenum 321 at the one or more attachment points 323 and/or to secure the one or more gooseneck arms 320 to the one or more support assemblies 322. These fasteners may include higher-strength fastener configurations or may include a greater number of fasteners to distribute loads more effectively. In this manner, the one or more gooseneck arms 320 and/or the one or more support assemblies 322 may be configured to maintain their structural integrity and/or to remain attached to the plenum 321 when subjected to the impact energy of an object impact.

In some embodiments, similar reinforcement configurations may be used for attaching the strut 325 to the plenum 321 at attachment point 328. For example, a support assembly 326 may be used to attach the strut 325 to the plenum 321 at the attachment point 328. In embodiments, the support assembly 326 may be reinforced, such as by constructing the support assembly 326 from reinforced materials in accordance with embodiments of the present disclosure described herein. In some embodiments, fasteners may be used to secure the support assembly 326 to the plenum 321 at the attachment point 328 and/or to secure the strut 325 to the support assembly 326. These fasteners may include higher-strength fastener configurations or may include a greater number of fasteners to distribute loads more effectively. In this manner, the strut 325 and/or the support assembly 326 may be configured to maintain their structural integrity and/or to remain attached to the plenum 321 when subjected to the impact energy of an object impact.

In embodiments, configuring the detaching components of the vent door assembly 300 (e.g., the vent door 310 and its associated support structures) may include configuring the vent door 310 to detach from the strut 325 and the one or more gooseneck arms in a controlled manner when subjected to an impact energy exceeding predetermined thresholds.

In the example configuration of FIG. 1, the vent door 310 may be attached to the strut 325 at attachment point 329 using a support assembly 327, which may be attached to the vent door 310 and the strut 325 using fasteners. Similarly, the vent door 310 may be attached to each of the one or more gooseneck arms 320 at the one or more attachment points 324 using a respective support assembly for each of the one or more gooseneck arms 320, which may be attached to the vent door 310 and the one or more gooseneck arms 320 using fasteners.

In embodiments, the controlled detachment of the vent door 310 may be facilitated by including a mechanical fuse 315 into the configuration of the vent door 310.

In embodiments, the mechanical fuse 315 may be configured to manage the transfer or distribution of the impact energy of an object impact by focusing and/or transferring the impact energy onto the one or more attachment points 324 attaching the vent door 310 to the one or more one or more gooseneck arms 320 and/or to the attachment point 329 attaching the vent door 310 to the strut 325. The transfer or focus of the impact energy onto the one or more attachment points 324 and/or the attachment point 329 may cause the one or more attachment points 324 and/or the attachment point 329 to fail in a controlled manner to detach the vent door 310 from the one or more one or more gooseneck arms 320 and/or the strut 325.

In embodiments, the one or more attachment points 324 and/or the attachment point 329 of the mechanical fuse 315 may be configured as weak points configured to fail in response to being subjected to the impact energy (e.g., when subjected to a kinetic energy exceeding predetermined thresholds). The configuration of the one or more attachment points 324 and/or the attachment point 329 as weak points may include application of various techniques. For example, in some embodiments, the material composition at the one or more attachment points 324 and/or the attachment point 329 may be configured to have lower strength characteristics compared to the surrounding areas. This localized reduction in material strength may allow the regions of the one or more attachment points 324 and/or the attachment point 329 to yield under impact forces while the rest of the structure maintains its integrity. Alternatively, or in addition, the vent door 310 may include features configured to concentrate stress at specific locations. For example, these features may include perforations, notches, and/or other geometric features that create stress concentration points at the one or more attachment points 324 and/or the attachment point 329. When subjected to impact forces, these areas may be more prone to failure, facilitating the controlled detachment of the vent door 310 from the one or more attachment points 324 and/or the attachment point 329.

In some embodiments, scoring may be applied to the vent door 310 near or at the one or more attachment points 324 and/or the attachment point 329. The scoring may include scoring lines that may create predetermined fracture paths, allowing the vent door 310 to separate along these scoring lines when exposed to sufficient impact energy. The depth, pattern, and/or location of these score lines may be configured to facilitate detachment of the vent door 310 while maintaining the vent door 310′s functionality during normal operations.

In embodiments, the mechanical fuse 315 may include fasteners at the attachment points 329 and/or the one or more attachment points 324 that are configured to fail under specific impact energy conditions. These mechanical fuse fasteners may operate to enable the controlled detachment of the vent door 310 from the one or more gooseneck arms 320 and/or the strut 325 during an impact event. For example, the fasteners attaching the vent door 310 to the support assembly 327 at attachment point 329 may include mechanical fuse fasteners. On the other hand, the fasteners attaching the support assembly 327 to the strut 325 may not be mechanical fuse fasteners configured for controlled failure but may instead include reinforced fasteners configured to withstand the impact energy to ensure that the support assembly 327 remains attached to the strut 325 during an object impact event. Similarly, the fasteners attaching the vent door 310 to the one or more gooseneck arms 320 at the one or more attachment points 324 may include mechanical fuse fasteners configured for controlled failure. On the other hand, the fasteners attaching the one or more gooseneck arms 320 to the plenum 321 may not be mechanical fuse fasteners configured for controlled failure but may instead include reinforced fasteners configured to withstand the impact energy to ensure that the one or more gooseneck arms 320 remain attached to the plenum 321 during the object impact event.

In embodiments, the performance characteristics of the mechanical fuse fasteners, and thus their mechanical failure characteristics, may be configured and/or fine-tuned through material selection. For example, certain metallic alloys may be chosen for the mechanical fuse fasteners for their ability to undergo controlled deformation and failure under predetermined stress conditions. In some embodiments, aluminum-based fasteners may be employed due to their unique mechanical properties. When subjected to the forces generated during an impact event, the mechanical fuse fasteners may exhibit a tendency to elongate before ultimately failing. This elongation may operate multiple purposes in the context of controlled mechanical failure. For example, such elongation may allow for some energy absorption during the initial stages of the impact, which may potentially reduce the overall severity of the event, especially as experienced by the non-detaching components of the vent door assembly 300. Additionally, the gradual elongation of the mechanical fuse fasteners may provide a brief delay in the detachment process, which may be beneficial in certain impact scenarios. Furthermore, once the mechanical fuse fasteners have elongated beyond their yield point, the mechanical fuse fasteners may no longer be capable of retaining the vent door 310, leading to vent door 310′s controlled separation or detachment from the one or more gooseneck arms 320 and/or strut 325.

In some embodiments, the mechanical fuse fasteners configuration may include specific geometric features to further control the failure process. For example, the mechanical fuse fasteners may include predetermined weak points or stress concentration areas that may be configured to initiate failure at specific locations. In embodiments, the weak points or stress concentration areas may be achieved by perforations or other forms of selective material reduction at specific locations along the mechanical fuse fastener. In some embodiments, the mechanical fuse fasteners may be configured as countersink fasteners with a conical shape, which may exhibit a lower pull-through resistance due to the inherent weakening of the face material caused by the conical geometry. These features may help ensure that the mechanical fuse fasteners fail in a predictable manner, which may enable the controlled detachment of the vent door 310.

In some embodiments, the mechanical fuse fasteners may include adhesive elements. These adhesives elements may be configured to maintain a strong bond sufficient to hold the vent door 310 under normal operating conditions but allow for separation or detachment when exposed to forces beyond a predetermined threshold. In some embodiments, the properties of these adhesives may be configured to complement the mechanical characteristics of the mechanical fuse fasteners.

In embodiments, the configuration of the mechanical fuse fasteners may be configured to ensure that the mechanical fuse fasteners can withstand the range of forces encountered during normal aircraft operation, including aerodynamic pressures and vibrations. However, when subjected to impact forces that exceed these normal operational parameters, the mechanical fuse fasteners may be configured to fail in a controlled manner, facilitating the detachment of the vent door 310 while minimizing the risk of uncontrolled separation or secondary impacts. In some embodiments, the configuration of the mechanical fuse fasteners may be configured to match the specific requirements of the vent door assembly 300. Factors such as the expected impact forces, the desired detachment threshold, the overall structural integrity of the assembly, etc. may influence the configuration and materials for the mechanical fuse fasteners.

In embodiments, the controlled detachment of the vent door 310 during an object impact event may be part of a hierarchical failure mechanism of the vent door assembly 300 that prioritizes the controlled detachment of specific components while preserving the integrity of others. This approach may allow for a predictable and managed response to object impacts, which may operate to minimize, mitigate and/or prevent damage to the aircraft and its systems. For example, the vent door 310 may be configured as a sacrificial component within the vent door assembly 300, configured to detach in a controlled manner when subjected to impact forces exceeding predetermined thresholds. This controlled detachment of the vent door 310 may serve as a form of energy dissipation, potentially reducing the transfer of impact forces to other critical components of the aircraft, and enabling the targeted configuration of the vent door 310 to prevent and/or mitigate damage to the other systems of the aircraft due to secondary impacts.

In contrast, the one or more gooseneck arms 320, the strut 325, and their associated support assemblies 326 and 323 may be configured to withstand higher impact energies and/or to remain attached to the vent door assembly 300 during the object impact event. Because of this configuration, the one or more gooseneck arms 320, the strut 325, and their associated support assemblies 326 and 323 may be reinforced or constructed from materials with higher strength-to-weight ratios, allowing them to maintain their structural integrity and attachment to the plenum 321 even under significant impact loads, without the risk of these components causing damage to other systems of the aircraft during an object impact event.

In embodiments, the vent door 310 may be configured to mitigate potential damage to other aircraft systems in the event of detachment from the one or more gooseneck arms 320 and/or the strut 325. In some embodiments, the vent door 310 may be configured with a failure energy coefficient that is less than a predetermined threshold. In embodiments, the predetermined threshold may be a value at which the vent door 310, based on the configuration of the vent door 310, may cause damage to one or more other systems of the aircraft due a secondary impact.

In some embodiments, the vent door 310 may be configured to be frangible and to undergo controlled fragmentation upon impact, resulting in the creation of smaller, less harmful pieces. This fragmentation may include shredding into thin, ribbon-like strips that lack the mass or rigidity to cause significant damage to other aircraft systems, and/or disintegration into a fine powder or small granules upon impact, effectively dispersing the energy and reducing the risk of concentrated force on other aircraft parts.

In some embodiments, the vent door 310 may be configured to break along predetermined stress lines or weak points. This controlled breakage may result in fragments of specific sizes and shapes that are less likely to cause damage to other systems of the aircraft such as propeller blades, engines, sensitive electronic equipment, flight control surfaces, etc. The size and shape of these fragments may be configured to ensure they do not possess sufficient mass or aerodynamic properties to inflict damage even if they come into contact with other parts of the aircraft.

In embodiments, the fragmentation of the vent door 310 may be based on the material composition of the vent door 310. For example, in some embodiments, the vent door 310 may be constructed from materials that exhibit brittle fracture characteristics under high-stress conditions and are configured to shatter into numerous small pieces upon impact, rather than breaking into larger, potentially more harmful fragments. Additionally, or alternatively, composite materials with specifically configured failure modes may be used for the vent door 310.

In some embodiments, the vent door 310 may include energy-absorbing structures or materials. These features may help dissipate the impact energy through deformation or crushing, which may reduce the potential for the detached door to cause damage to other aircraft systems. The energy absorption may also contribute to the fragmentation process, which may facilitate the resulting pieces having a lower kinetic energy.

In embodiments, the vent door 310 may be configured to fragment and/or to absorb impact energy at different stages of the object impact event. For example, in some embodiments, the vent door 310 may be configured to fragment and/or to absorb impact energy during the initial object impact, dispersing the impact energy and reducing the risk of damage to the aircraft structure due to secondary impacts. Alternatively, or additionally, the vent door 310 may be configured to separate or detach from the assembly in a whole or substantially whole form during the initial object impact but may be configured to fragment and/or to absorb impact energy upon a secondary impact with another system of the aircraft. For example, if the detached vent door 310 were to come into contact with a critical system such as a propeller or engine, the vent door 310 may be configured to break apart into smaller, less harmful pieces upon this secondary impact, and/or to absorb the energy of the secondary impact, without causing significant damage to the critical system. This fragmentation and/or to energy absorption during the secondary impact may help dissipate the secondary impact energy and may reduce the potential for significant damage to the other aircraft system.

In embodiments, the one or more gooseneck arms 320 and the strut 325, and their associated support structures, may be implemented as non-detaching components within the vent door assembly 300. This configuration may include reinforcing the one or more gooseneck arms 320 and the strut 325, and their associated support structures, to enhance their ability to withstand impact forces and remain securely attached to the plenum of the vent door assembly 300 during object impact events. The reinforcement of the one or more gooseneck arms 320 and the strut 325, and their associated support structures, may include configuring the failure energy coefficient of the one or more gooseneck arms 320 and the strut 325, and their associated support structures to be substantially higher than the failure energy coefficient of the vent door 310, which may operate to ensure that the one or more gooseneck arms 320 and the strut 325, and their associated support structures, remain undamaged even when the vent door 310 detaches as intended.

In embodiments, the configuration of the vent door 310 and the one or more gooseneck arms 320 and the strut 325, and their associated support structures, may include a disparity between the failure energy coefficients of the one or more gooseneck arms 320 and the strut 325, and their associated support structures, and the vent door 310. In embodiments, the failure energy coefficient disparity may be intentional and configured to ensure that the one or more gooseneck arms 320 and the strut 325, and their associated support structures, remain intact and attached to the aircraft component assembly 200 during impact events that may cause the vent door 310 to detach or break apart from the aircraft component assembly.

For example, in embodiments, the failure energy coefficient of the one or more gooseneck arms 320 and the strut 325, and their associated support structures, may be configured to be substantially higher than the failure energy coefficient of the vent door 310. This difference in failure energy coefficients may be configured to implement the controlled failure mechanism of the vent door assembly 300. In some specific embodiments, the failure energy coefficient of the vent door 310 may be set to a fraction of failure energy coefficient of the one or more gooseneck arms 320 and the strut 325, and their associated support structures. For example, in a specific example, the failure energy coefficient of the vent door 310 may range from 5% to 30% of the failure energy coefficient of the one or more gooseneck arms 320 and the strut 325, and their associated support structures.

It should be noted that the specific ratios between the failure energy coefficients of the one or more gooseneck arms 320 and the strut 325, and their associated support structures, and the vent door 310 discussed herein are provided by way of illustration and are not intended to be limiting in any way. Indeed, the specific ratios between the failure energy coefficients of the vent door 310 and the one or more gooseneck arms 320 and the strut 325, and their associated support structures, may vary depending on the particular application, configuration, and/or component parts involved. The exact percentages may be configured to meet the requirements of different aircraft systems, taking into account factors such as the expected impact forces, the critical nature of the components, the overall safety objectives of the aircraft design, etc.

In embodiments, the vent door 310 may be configured as a non-damaging component. In these embodiments, the vent door 310 may be configured to minimize or prevent the damage caused to other systems of the aircraft during a secondary impact. For example, in embodiments, the vent door 310 may be constructed from materials having non-damaging properties. These materials may be configured to maintain the structural integrity of the vent door 310 during normal operation while exhibiting benign characteristics upon secondary impact after detachment of the vent door 310 from the vent door assembly 300. For example, the vent door 310 may be constructed from composites or polymers that may have sufficient structural strength for normal operation but deform or yield in a manner that minimizes potential harm to other aircraft systems in the event of a secondary impact.

FIG. 3B shows a diagram of the vent door assembly 300 during operations for controlling the mechanical failure due to an object impact and for mitigating a secondary impact of components of the vent door assembly 300 against other systems of the aircraft in accordance with embodiments of the present disclosure. In particular, FIG. 3B illustrates the vent door assembly 300 in a post-impact state, demonstrating the controlled mechanical failure mechanism configured to mitigate potential secondary impacts. In this example, an object has struck the vent door assembly 300 and mechanical fuse 315 has focused the impact energy onto the attachment points 324 and 329, causing the vent door 310 to separate or detach from the one or more gooseneck arms 320 and the strut 325, while the one or more gooseneck arms 320 and the strut 325, and their associated support structures, maintain their structural integrity and attachment to the vent door assembly 300. In this example, the vent door 310 is effectively in free flight.

In this example, the detachment of the vent door 310 illustrates the vent door assembly 310′s ability to manage impact forces in a predictable manner. This controlled separation of vent door 310 may serve multiple purposes, including energy dissipation and reduction of stress on the overall aircraft structure. The one or more gooseneck arms 320, the strut 325, and their associated support structures remain securely attached to the vent door assembly 300, highlighting the differential response of various components to impact forces.

The example illustrated in FIG. 3B further highlights the functionality of the vent door 310 to mitigate and/or prevent damage to other systems of the aircraft due to secondary impacts. In particular, due to the controlled failure functionality that allows the vent door assembly 300 to manage the manner and location of the mechanical failure due to the object impact event, the vent door assembly 300 can be configured to detach the vent door 310 in response to the object impact event, which may allow for the configuration of the vent door 310 to prevent and/or mitigate damage to the other systems of the aircraft.

In embodiments, the functionality of the vent door 310 to prevent and/or mitigate damage to the other systems of the aircraft may include configuration of the vent door 310 as a frangible. As such, the vent door 310 may be configured to fragment or deform in a way that minimizes potential damage to other components of the aircraft, such as engines, propellers, or sensitive electronic equipment due to secondary impacts. In this example, this fragmentation or deformation may occur upon a subsequent secondary impact or collision of vent door 310.

In this example, the retention of the non-detaching components, including the one or more gooseneck arms 320 and the strut 325, and their associated support structures, may contribute to the overall safety of the vent door assembly 300 by preventing these larger, heavier, reinforced, and/or potentially more harmful components from becoming projectiles during or after the object impact event. This configuration may help maintain the structural integrity of the vent door assembly 300 and minimize the risk of cascading failures in other aircraft systems.

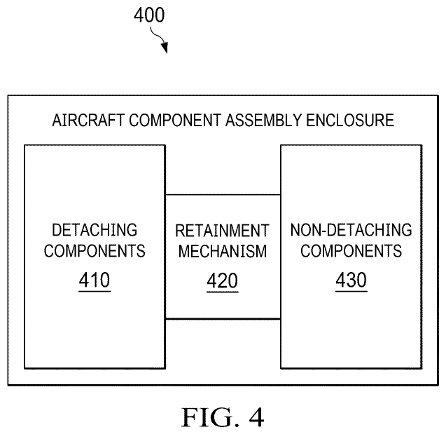

FIG. 4 shows a diagram of an exemplary aircraft component assembly 400 configured with capabilities and functionality for controlling a mechanical failure due to an object impact and for preventing secondary impacts against other systems of the aircraft in accordance with embodiments of the present disclosure. In embodiments, the aircraft component assembly 400 may be implemented in an aircraft such as aircraft system 150 shown in FIG. 1. In embodiments, the structure and functionality of the aircraft component assembly 400 shown in FIG. 4 may include functionalities and components similar to those described with respect to the aircraft component assemblies in FIGS. 2, 3A, and 3B (e.g., the aircraft component assembly 200 and/or the vent door assembly 300). For example, the aircraft component assembly 400 may be configured to manage mechanical failure resulting from object impacts while preventing potential secondary impacts on other aircraft systems. As shown in FIG. 4, aircraft component assembly 400 may include one or more detaching components 410, a retainment mechanism 420, and one or more non-detaching components 430.

In particular, the functionality of the aircraft component assembly 400 for controlling a mechanical failure due to an object impact may be similar to the configuration of the aircraft component assembly 200 for controlling a mechanical failure due to an object impact. For example, in embodiments, the aircraft component assembly 400 may include a mechanical fuse system (e.g., with functionality similar to mechanical fuse 220), which may be configured to limit and direct impact energy to specific attachment points. This configuration may allow for the controlled detachment of the one or more detaching components 410 while ensuring that the one or more non-detaching components 430 remain securely fastened to the aircraft component assembly 400. The mechanical fuse may be configured to focus the impact energy on predetermined weak points, facilitating a predictable failure pattern in the event of an object impact.

In some embodiments, the one or more detaching components 410 may be configured as frangible components. This configuration may allow the one or more detaching components 410 to fragment upon secondary impact with other aircraft systems, potentially reducing or minimizing damage to those systems. The fragmentation process may help dissipate impact energy and reduce the risk of concentrated force being applied to critical aircraft components.

In embodiments, the configuration of the aircraft component assembly 400 for preventing secondary impacts against other systems of the aircraft may include configuration to include a retainment mechanism 420 configured to prevent secondary impacts of the one or more detaching components 410 in response to the object impact. For example, in embodiments, the retainment mechanism 420 may be configured to prevent the complete detachment of the one or more detaching components 410 from the aircraft component assembly 400 to prevent the secondary impacts. In embodiments, the retainment mechanism 420 may employ various techniques to achieve its functionality, such as tethering or partial containment of the one or more detaching components 410. In embodiments, the functionality of the retainment mechanism 420 may provide an extra layer of protection against secondary impacts, even in scenarios where the one or more detaching components separate from the aircraft component assembly 400.

In embodiments, the retainment mechanism 420 may be configured to retain the one or more detaching components 410 after they have separated from the one or more non-detaching components 430. This configuration may prevent the one or more detaching components 410 from completely disconnecting from the aircraft component assembly 400, which may operate to prevent the risk of secondary impacts against other aircraft systems.

In embodiments, the retainment mechanism 420 may include a tether system configured to maintain a connection between the aircraft component assembly 400 and the one or more detaching components 410 after detachment. This tether system may be configured to withstand the forces generated during an object impact event, ensuring that the tether system remains securely fastened to both the aircraft component assembly 400 and the one or more detaching components 410 even after the initial object impact.

In embodiments, the tether system may be configured with sufficient length and flexibility to allow the one or more detaching components 410 to separate from their original attachment points on the aircraft component assembly 400 or the one or more non-detaching components 430. In some embodiments, this controlled detachment may serve to dissipate impact energy and reduce stress on the overall structure. However, the tether system may prevent the one or more detaching components from completely separating from the aircraft component assembly 400, effectively limiting their range of detachment. In embodiments, by maintaining a physical connection between the detached one or more detaching components 410 and the aircraft component assembly 400, the tether system may significantly reduce and effectively prevent the risk of secondary impacts. This configuration may prevent the detached one or more detaching components 410 from becoming free-flying objects that may potentially collide with and damage other systems of the aircraft, such as propeller blades, engines, sensitive avionics equipment, flight control surfaces, etc.

In embodiments, the tether system may be constructed from materials having high tensile strength and appropriate elasticity, such as high-strength fibers, cables, flexible composites, etc. These properties may allow the tether system to absorb additional energy during the detachment process while maintaining the integrity of the connection to the one or more detaching components 410. In some embodiments, the tether system may include energy-absorbing elements or be configured with a specific failure mode that further mitigate the transfer of impact forces to the rest of the aircraft structure.

In some embodiments, by retaining the detached one or more detaching components 410 in close proximity to the aircraft component assembly 400, the tether system may also facilitate easier post-incident inspections and potentially simplify repair or replacement procedures after an object impact. This may contribute to the overall safety and maintainability of the aircraft system.

In embodiments, the retainment mechanism 420 may include a compliant containment system configured to actively manage the retainment of the one or more detaching components 410. This compliant containment system may be securely anchored at one end to the enclosure 555 of the aircraft component assembly 400 to ensure its continued attachment even in the event of an object impact. The other end of the compliant containment system may be connected to the one or more detaching components 410.

In embodiments, upon detachment of the one or more detaching components 410 from the aircraft component assembly 400 or the one or more non-detaching components 430, the compliant containment system may activate. This activation may result in a controlled retraction of the detached one or more non-detaching components 430, drawing the one or more non-detaching components 430 back towards or into the enclosure 555 of the aircraft component assembly 400. This retraction operation may effectively prevent the detached one or more non-detaching components 430 from becoming free-flying objects and may instead contain the one or more non-detaching components 430 within the enclosure 555. By containing the one or more detaching components 410 within the enclosure 555, the compliant containment system may effectively prevent the one or more non-detaching components 430 from colliding with other systems of the aircraft preventing secondary impacts.

In embodiments, the compliant containment system may be configured with specific tension and retraction characteristics to optimize performance under various impact scenarios. These characteristics may be configured to account for the mass and potential momentum of the one or more detaching components 410, ensuring effective containment without introducing excessive stress on the remaining assembly structure. In embodiments, the compliant containment system may include springs, flexural hinges, bistable mechanisms that can snap between two stable states, torsional flexures that provide rotational compliance through twisting, flexible cables or tendons, and elastic membranes that stretch and retract. Additionally, or alternative, shape memory alloys (SMA) can be used to return the one or more detaching components 410 to their original position through thermal activation, and beam-based flexures or cantilever mechanisms can provide controlled bending for restoring force. Compliant beams with variable stiffness may also be used to tailor the deformation characteristics, while bellows mechanisms, with accordion-like structures, can provide expandable and contractible containment.

In some embodiments, the implementation of the retainment mechanism 420 into the aircraft component assembly 400 may enable alternative configurations for the one or more detaching components 410. For example, since the one or more detaching components 410 remain connected to the aircraft component assembly 400 even after detachment, the one or more detaching components 410 may be configured to be reinforced to increase their structural integrity. This may enable the use of more robust materials or reinforced structures for the one or more detaching components 410, which may improve their performance during normal operation and their resilience during impact events without posing risks of secondary impact damage to other aircraft parts.

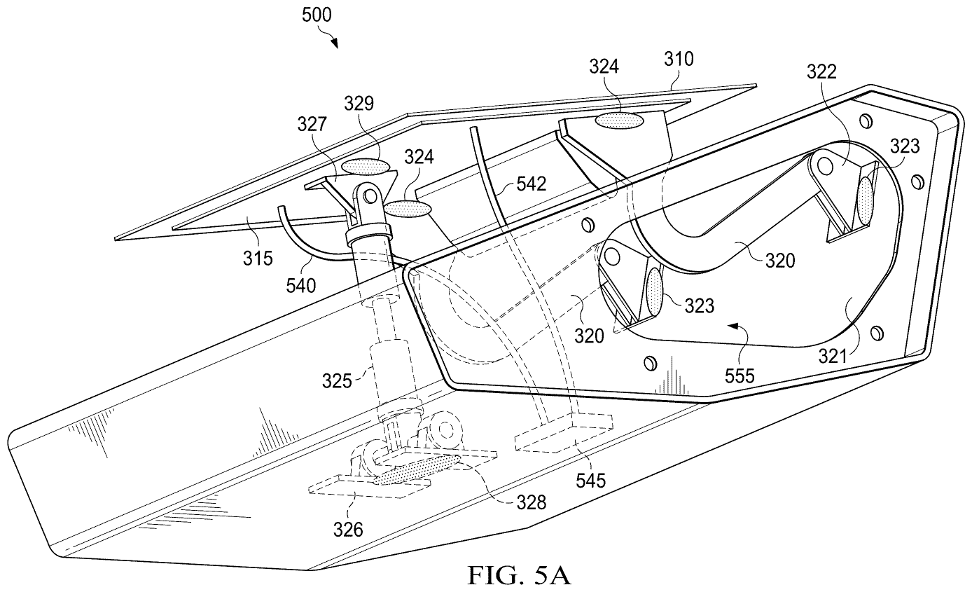

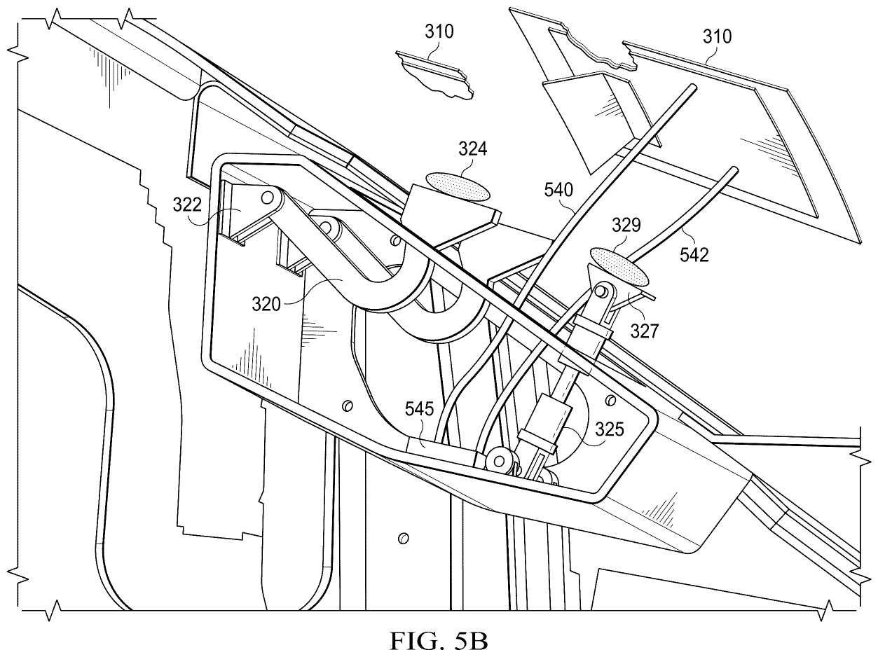

FIG. 5A shows a diagram of a vent door assembly 500 configured with capabilities and functionality for controlling the mechanical failure due to an object impact and for preventing secondary impacts against other systems of an aircraft in which the vent door assembly 500 is installed in accordance with embodiments of the present disclosure. Vent door assembly 500 may represent a particular implementation of the aircraft component assembly 400 described with reference to FIG. 4 and may include the functionalities described with respect to aircraft component assembly 400.

In embodiments, the vent door assembly 500 may include functionality, structure, and configuration similar to the functionality, structure, and configuration of the vent door assembly 300 described in relation to FIGS. 3A and 3B. This configuration may allow the vent door assembly 500 to effectively manage ram air flow into the aircraft cabin, providing necessary ventilation and pressure regulation during flight operations.

In embodiments, the vent door assembly 500 may be configured to control the mechanical failure due to an object impact and for mitigating a secondary impact of components of the vent door assembly 500 against other systems of the aircraft in accordance with embodiments of the present disclosure. In particular, the vent door assembly 500 may be configured to respond to object impacts in a controlled manner, according to functionality similar to the functionality of the vent door 300 for controlling a mechanical failure due to an object impact. For example, in embodiments, the vent door assembly 500 may include a mechanical fuse 315, which may be configured to limit and direct impact energy to specific attachment points. This configuration may allow for the controlled detachment of the vent door 310 while ensuring that the non-detaching components of the vent door assembly 500 (e.g., the one or more gooseneck arms 320 and/or the strut 325, and their associated support structures 327, 326, and/or 322) remain securely attached to the vent door assembly 500. The mechanical fuse 315 may be configured to focus the impact energy on predetermined weak points, facilitating a predictable failure pattern in the event of an object impact.

In some embodiments, the vent door 310 may be configured as a frangible component configured to fragment upon either the initial object impact and/or a secondary impact with other aircraft systems.

In embodiments, the configuration of the vent door assembly 500 for preventing secondary impacts against other systems of the aircraft may include configuration to include a retainment mechanism 545 configured to prevent secondary impacts of the vent door 310 in response to the object impact. In embodiments, the functionality of the retainment mechanism 545 may be similar to the functionality of the retainment mechanism 420 described with reference FIG. 4. For example, in embodiments, the retainment mechanism 545 may be configured to maintain a connection between the vent door 310 and the plenum 321, even in scenarios where the impact forces are sufficient to detach the vent door 310 from its primary support structures, such as the one or more attachment points 324 with the one or more gooseneck arms 320 and the attachment point 329 with the strut 325. In this manner, the retainment mechanism 545 may operate to prevent the complete separation of the vent door 310 from the vent door assembly 300. This may be particularly important for preventing the detached vent door 310 from becoming a projectile that may potentially cause secondary impacts and damage to other systems of the aircraft. By keeping the vent door 310 tethered to the plenum 321 and/or contained within the enclosure 555, the retainment mechanism 545 may operate to reduce and/or eliminate the risk of secondary impacts due to an object impact.

In embodiments, the retainment mechanism 545 may include a tether system 542 and/or a compliant containment system 540. In embodiments, the tether system 542 may be configured to maintain a physical connection between the vent door 310 and the plenum 321 of the vent door assembly 300. This tether system 542 may be configured with sufficient strength to withstand the forces generated during an impact while also providing enough flexibility to allow for some controlled movement of the vent door 310. The functionality of the tether system 542 may be similar to the functionality of the tether system described with reference to the retainment mechanism 420 of FIG. 4.

In embodiments, the compliant containment system 540 may be configured to pull or retract the detached vent door 310 back towards or into the enclosure 555 of the vent door assembly 500. This retraction functionality may help to quickly remove the detached vent door 310 from the airstream, which may minimize or eliminate the risk of interaction with other aircraft systems.

In embodiments, the combination of the tether system 542 and the compliant containment system 540 may provide a robust system for managing the detachment of the vent door 310 to prevent damage from secondary impacts. While the tether system 542 may prevent the vent door 310 from completely separating from the vent door assembly 500, the compliant containment system 540 may actively work to return the detached vent door 310 to a safer position within the enclosure 555. This dual-component system may offer redundancy, enhancing the overall reliability of the retainment mechanism 545.

By preventing the vent door 310 from becoming a free-flying object, the retainment mechanism 545 may significantly reduce the risk of secondary impacts. This may be particularly important for protecting critical aircraft systems such as engines, propellers, sensitive avionics equipment, etc. which could potentially suffer severe damage from impact with a detached vent door 210. The containment of the vent door 310 within or close to the enclosure 555 may also facilitate easier post-incident inspections and potentially simplify repair or replacement procedures.

FIG. 5B shows a diagram of the vent door assembly 500 during operations for controlling the mechanical failure due to an object impact and for preventing a secondary impact of components of the vent door assembly 500 against other systems of the aircraft in accordance with embodiments of the present disclosure. In particular, FIG. 5B illustrates the vent door assembly 500 in a post-impact state, demonstrating the controlled mechanical failure mechanism configured to mitigate potential secondary impacts. In this example, an object has struck the vent door assembly 500 and mechanical fuse 315 has focused the impact energy onto the attachment points 324 and 329, causing the vent door 310 to separate or detach from the one or more gooseneck arms 320 and the strut 325, while the one or more gooseneck arms 320 and the strut 325, and their associated support structures, maintain their structural integrity and attachment to the vent door assembly 300.

However, in this example, the vent door 310 is not a free-flying object, as the retainment mechanism 545 operates to prevent the complete separation of the vent door 310 from the vent door assembly 500, and to effectively precent the risk of secondary impacts. In this example, the tether system 542 may operate to maintain a physical connection between the vent door 310 and the plenum 321 of the vent door assembly 500, while the compliance containment system 540 may operate to actively retract the detached door 310 into the enclosure 555 of the vent door assembly 500. As such, the functionality of the retainment mechanism 545 extends beyond keeping the vent door 310 physical attached to the vent door assembly 500 but may also operate to guide the detached vent door 310 into a position where it poses minimal risk to other aircraft systems (e.g., within the enclosure 555 of the vent door assembly 500). This controlled retention may effectively eliminate the likelihood of the detached vent door 310 interacting with critical components such as propellers, engines, sensitive avionics equipment, etc.

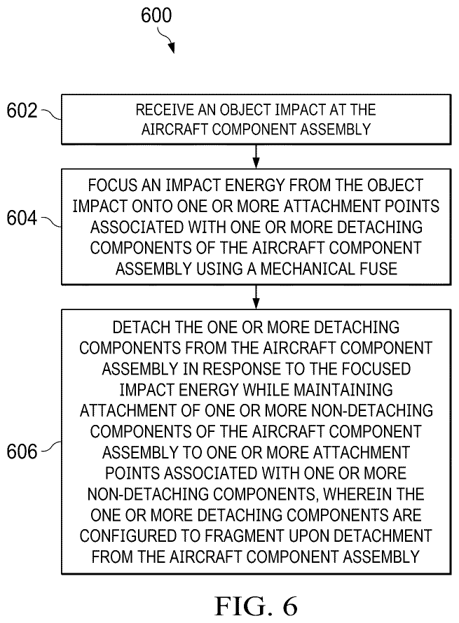

FIG. 6 is a high-level flow diagram of a method 600 for controlling mechanical failure of an aircraft component assembly and mitigating damage due to potential secondary impacts in accordance with embodiments of the present disclosure. In embodiments, the steps of method 600 may be implemented by an aircraft component assembly (e.g., aircraft component assembly 200 of FIG. 2, vent door assembly 300 of FIGS. 3A and 3B, aircraft component assembly 400 of FIG. 4, and vent door assembly 500 of FIGS. 5A and 5B).

At block 602, an object impact is received at the aircraft component assembly. For example, in embodiments, an object (e.g., object 110 illustrated in FIG. 1) may collide or impact an aircraft component assembly (e.g., aircraft component assembly 200 of FIG. 2, vent door assembly 300 of FIGS. 3A and 3B, aircraft component assembly 400 of FIG. 4, and vent door assembly 500 of FIGS. 5A and 5B) according to configuration and functionality described with respect to embodiments of the present disclosure and with respect to FIGS. 1-5B.

At block 604, an impact energy from the object impact is focused onto one or more attachment points associated with one or more detaching components of the aircraft component assembly using a mechanical fuse. For example, in embodiments, a mechanical fuse (e.g., the mechanical fuse 220 of FIG. 2 and/or the mechanical fuse 315 of FIGS. 3A, 3B, 5A, and 5B) may be used to focus the impact energy from the object impact onto one or more attachment points (e.g., attachment points 329 and/or 324 of FIGS. 3A, 3B, 5A, and 5B) associated with one or more detaching components (e.g., one or more frangible components 210 of FIG. 2, vent door 310 of FIGS. 3A, 3B, 5A, and 5B, and/or one or more detaching components 410 of FIG. 4) of the aircraft component assembly (e.g., aircraft component assembly 200 of FIG. 2, vent door assembly 300 of FIGS. 3A and 3B, aircraft component assembly 400 of FIG. 4, and vent door assembly 500 of FIGS. 5A and 5B)

At block 606, the one or more detaching components are detached from the aircraft component assembly in response to the focused impact energy while maintaining attachment of one or more non-detaching components of the aircraft component assembly to one or more attachment points associated with one or more non-detaching components. For example, the one or more detaching components (e.g., one or more frangible components 210 of FIG. 2, vent door 310 of FIGS. 3A, 3B, 5A, and 5B, and/or one or more detaching components 410 of FIG. 4) are detached from the aircraft component assembly (e.g., aircraft component assembly 200 of FIG. 2, vent door assembly 300 of FIGS. 3A and 3B, aircraft component assembly 400 of FIG. 4, and vent door assembly 500 of FIGS. 5A and 5B) in response to the focused impact energy while maintaining attachment of one or more non-detaching components (e.g., one or more non-detaching components 210 of FIG. 2, the one or more gooseneck arms 320 and/or strut 325 of FIGS. 3A, 3B, 5A, and 5B, and/or one or more non-detaching components 410 of FIG. 4) of the aircraft component assembly to one or more attachment points (e.g., the one or more attachment points 323 and/or the attachment point 328 of FIGS. 3A, 3B, 5A, and 5B) associated with one or more non-detaching components.

In embodiments, the one or more detaching components are configured to fragment upon detachment from the aircraft component assembly. For example, the one or more detaching components may be configured as low-energy frangible components, configured to shred, break apart, or otherwise fragment when subject an impact energy (e.g., the impact energy of the object impact or a secondary impact against other systems of the aircraft). In embodiments, the frangibility of the one or more detaching components may be determined by the failure energy coefficient of the one or more detaching components, which may be configured with respect to the failure energy coefficient of the one or more non-detaching component. In some embodiments, the failure energy coefficient of the one or more detaching components may be between 0.05 and 0.3 of the failure energy coefficient of the one or more non-detaching components.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are in-tended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. An aircraft component assembly, comprising:
one or more detaching components configured to detach from the aircraft component assembly in response to an object impact against the aircraft component assembly, wherein the one or more detaching components are attached to the aircraft component assembly at one or more attachment points associated with the one or more detaching components;
one or more non-detaching components configured to remain attached to the aircraft component assembly during the object impact against the aircraft component assembly, wherein the one or more non-detaching components are attached to the aircraft component assembly at one or more attachment points associated with the one or more non-detaching components; and
a mechanical fuse configured to focus an impact energy from the object impact onto the one or more attachment points associated with the one or more detaching components to cause the one or more attachment points associated with the one or more detaching components to fail and to cause a controlled detachment of the one or more non-detaching components from the aircraft component assembly while maintaining attachment of the one or more non-detaching component to the aircraft component assembly.

2. The aircraft component assembly of claim 1, wherein the one or more detaching components are configured to fragment upon detachment from the aircraft component assembly.

3. The aircraft component assembly of claim 2, wherein the one or more detaching components are configured to fragment into pieces smaller than a predetermined size to reduce potential damage to other aircraft systems.

4. The aircraft component assembly of claim 2, wherein the one or more detaching components are configured to fragment upon a secondary impact against other aircraft systems without causing damage to the other aircraft systems.

5. The aircraft component assembly of claim 1, wherein the mechanical fuse comprises fasteners configured to fail at a predetermined failure energy value.

6. The aircraft component assembly of claim 5, wherein the fasteners comprise a material configured to elongate before failing when subjected to the impact energy.

7. The aircraft component assembly of claim 1, wherein the one or more non-detaching components are reinforced to withstand the object impact without detaching from the aircraft component assembly.

8. The aircraft component assembly of claim 1, wherein the one or more detaching components have a failure energy coefficient that is a predetermined fraction of a failure energy coefficient of the one or more non-detaching components.

9. The aircraft component assembly of claim 8, wherein the failure energy coefficient of the one or more detaching components is between 5% and 30% of the failure energy coefficient of the one or more non-detaching components.

10. The aircraft component assembly of claim 1, wherein the attachment of the one or more detaching components to the aircraft component assembly at the one or more attachment points associated with the one or more detaching components includes attachment of the one or more detaching components to the one or more non-detaching components.

11. The aircraft component assembly of claim 10, wherein the one or more attachment points associated with the one or more detaching components are configured to fail at a failure energy level that is between 5% and 30% of the failure energy level at which the one or more attachment points associated with the one or more non-detaching components are configured to fail.

12. A method of controlling mechanical failure of an aircraft component assembly, comprising:
receiving an object impact at the aircraft component assembly;
focusing an impact energy from the object impact onto one or more attachment points associated with one or more detaching components of the aircraft component assembly using a mechanical fuse; and
detaching the one or more detaching components from the aircraft component assembly in response to the focused impact energy while maintaining attachment of one or more non-detaching components of the aircraft component assembly to one or more attachment points associated with one or more non-detaching components, wherein the one or more detaching components are configured to fragment upon detachment from the aircraft component assembly.

13. The method of claim 12, wherein the one or more detaching components are configured to fragment into pieces smaller than a predetermined size to reduce potential damage to other aircraft systems.

14. The aircraft component assembly of claim 13, wherein the one or more detaching components are configured to fragment upon a secondary impact against other aircraft systems without causing damage to the other aircraft systems.

15. The method of claim 12, wherein the mechanical fuse comprises fasteners configured to fail at a predetermined failure energy value.

16. The method of claim 12, wherein the one or more non-detaching components are reinforced to withstand the object impact without detaching from the aircraft component assembly.

17. The method of claim 12, wherein the one or more detaching components have a failure energy coefficient that is between 5% and 30% of a failure energy coefficient of the one or more non-detaching components.

18. The method of claim 12, wherein the one or more attachment points associated with the one or more detaching components includes attachment between the one or more detaching components to the one or more non-detaching components.

19. The method of claim 18, wherein the one or more attachment points associated with the one or more detaching components are configured to fail at a failure energy level that is between 5% and 30% of the failure energy level at which the one or more attachment points associated with the one or more non-detaching components are configured to fail.

20. An aircraft system, comprising:
a vent door assembly including a vent door, one or more gooseneck arms, and a strut;
a mechanical fuse configured to focus impact energy from an object impact onto one or more attachment points connecting the vent door to the one or more gooseneck arms and the strut; and
a retainment mechanism configured to maintain a connection between the vent door and the vent door assembly after detachment of the vent door from the one or more gooseneck arms and the strut in response to the object impact.
